(19) United States
(12) Patent Application Publication
(10) Pub. No.: US 2014/0326043 A1
(43) Pub. Date: Nov. 6, 2014

(54) Energy store, system including the energy store, and method for ascertaining the state of health of an energy store

(71) Applicants: Marcus Wegner, Leonberg (DE); Jens Grimminger, Leonberg (DE); Martin Tenzer, Unterensingen (DE); Jean Fanous, Stuttgart (DE)

(72) Inventors: Marcus Wegner, Leonberg (DE); Jens Grimminger, Leonberg (DE); Martin Tenzer, Unterensingen (DE); Jean Fanous, Stuttgart (DE)

(21) Appl. No.: 14/346,520

(22) PCT Filed: Jul. 17, 2012
(86) PCT No.: PCT/EP2012/064010

§ 371 Date: Jun. 27, 2014

(30) Foreign Application Priority Data
Sep. 22, 2011 (DE) 10 2011 083 165.7

(51) Int. Cl. G01N 30/00; H01J 49/26

(52) U.S. Cl. CPC G01N 30/00; H01J 49/26
USPC 73/23.37

(57) ABSTRACT

An energy store, in particular to a lithium-based energy store. In order to make a simple and exact determination of a state of health, e.g., the aging condition, possible, the energy store includes at least one cell having an anode, a cathode, and an electrolyte which is situated between the anode and the cathode, at least one cell having an outlet for conveying functional material from the cell to an analysis unit and the outlet being connectable to the analysis unit in a fluid-tight manner. Also described is a system including the energy store and an analysis unit, and a method for ascertaining a state of health of an energy store.

### FIELD OF THE INVENTION

The present invention relates to an energy store, in particular to a lithium-based battery, whose state of health is ascertainable in a particularly simple and exact manner. The present invention furthermore relates to a system including the energy store and a method for ascertaining a state of health of an energy store, such as in particular an aging condition.

### BACKGROUND INFORMATION

Energy stores, such as, in particular, lithium-based batteries, are very common nowadays and are employable in many areas of application, e.g., mobile or stationary areas of application. With regard to their utilization, it is advantageous to be able to ascertain their aging condition in defined intervals. The aging condition is also referred to in this case as state of health (SOH). In this way, information regarding the further service life of the energy store may be obtained in particular.

In energy stores which are common nowadays, e.g., in particular in lithium-based batteries, i.e., lithium batteries and lithium-ion batteries, the aging condition may, in particular, be inferred from an ascertainment of the capacity or from an ascertainment of the decrease in capacity. Another possibility is to ascertain the internal resistance or an increase in the internal resistance. These variables may generally be ascertained relatively easily. Within certain limits, they allow for prognoses of the service life of the energy store which remains to be expected, prognoses of the reliability of the energy store in the near future, or also prognoses of information regarding a possibly imminent failure of the energy store.

### SUMMARY OF THE INVENTION

The subject matter of the present invention is an energy store, in particular a lithium-based energy store, including at least one cell having an anode, a cathode, and an electrolyte which is situated between the anode and the cathode, at least one cell having an outlet for conveying functional material from the cell to an analysis unit and the outlet being connectable to the analysis unit in a fluid-tight manner.

In the sense of the present invention, an energy store may, in particular, be an electrochemical component which is capable of storing energy, e.g., in particular electrical energy, and releasing it in a desired manner. In particular, an energy store may be a battery or a rechargeable battery. For example, the energy store may be a lithium-based energy store. A lithium-based energy store in this case includes both lithium batteries and lithium-ion batteries, for example. Here, lithium batteries, in contrast to lithium-ion batteries, usually include an anode made of metallic lithium or of a metallic lithium alloy. Lithium-ion batteries may in contrast include an anode made of graphite, for example, into which lithium ions may be intercalated. A lithium sulfur battery is named here in a non-limiting manner as a concrete example of a lithium-ion battery.

The energy store includes in this case at least one cell having an anode, a cathode, and an electrolyte which is situated between the anode and the cathode. Here, the energy store may have only one cell or also a plurality of cells which are connected in parallel and/or in series. Each cell has a fundamental structure which is known per se and includes an anode, a cathode, and an electrolyte which is situated in-between. Depending on whether a lithium battery or a lithium-ion battery is to be used, for example, the anode may have metallic lithium or a lithium alloy, or graphite, for example. Possible cathode materials include lithium-intercalating metal oxides or, for example, sulfur- and carbon-based cathodes or materials. Carbonates, e.g., ethylene carbonate (EC) or dimethyl carbonate (DMC), dioxolane, dimethyl ether, or tri- or tetramethylene glycol dimethyl ether may be used as the electrolyte, the materials mentioned above should not be understood in a limiting manner.

Furthermore, at least one cell may have an outlet for conveying functional material from the cell to an analysis unit. In the sense of the present invention, this may in particular mean that the outlet is fluidically connected to the interior of the cell. For this purpose, the outlet may, for example, be situated in a housing which surrounds the cell. The outlet may in this case be a suitable opening, for example, which may be closable. Furthermore, for the case that the energy store has a plurality of cells, the outlet of the cell or cells may, for example, be connected to a terminal which is situated in a housing of the overall energy store. A fluid connection of the outlet to the cell or to its interior may, for example, be implemented via a connecting arrangement which leads from a suitable position inside the cell to the outlet in order to be able to suitably remove the functional material out of the inside of the cell.

The outlet may in particular be used to convey functional material out of the cell to an analysis unit, in particular at a defined time and in a defined quantity. For this purpose, the outlet may be, in particular, connectable to the analysis unit in a fluid-tight manner. In order to implement such a fluid-tight connection, the outlet may, for example, be fluidically connected to a terminal of the energy store or, for example, have a terminal itself which may be connected to the analysis unit in a fluid-tight manner via a connecting arrangement, for example, such as a connecting capillary, a hose, or the like. The terminal may in this case also include a screw thread, for example, or be configured as such.

In the sense of the present invention, fluid-tight may in particular mean that a connection is involved which is capable of conveying a fluid, such as in particular a gas or a liquid, without the risk of undesirable fluid leakage or without the risk that fluid may enter the connection undesirably. In this way, on the one hand, it is ensured that the functional material does not leak unintentionally and thus gets lost. And on the other hand, it is ensured in the case of an established connection between the energy store or the cell and the analysis unit that the cell is hermetically closed and cannot be entered by ambient air, for example.

With the aid of a fluid-tight connection between the outlet and the analysis unit, functional material may be transferred to the analysis unit and analyzed there qualitatively and/or quantitatively, in particular. For this purpose, the outlet may, for example, be connectable or connected to a removal device, such as a pump, for example.

In the sense of the present invention, functional material may in this case be any type of compound or substance, in particular, which is present inside the cell or may be formed there during the operation of an energy store. For example, functional material may in this case include the anode material, the cathode material and/or the electrolyte material. Furthermore, functional material may include breakdown products or decomposition products of the anode material, the cathode material and/or the electrolyte material. In another non-limiting example, functional material may include reaction products of the anode material, the cathode material and/or the electrolyte material. This includes both desirable reaction products, i.e., for example, those products which are formed, for example, as part of the electrochemical processes which take place during a charging or discharging process of the energy store, and those reaction products which may be generated undesirably, for example, as a result of a reaction, for example, of the anode material, the cathode material and/or the electrolyte material among each other, for example. In the sense of the present invention, the term functional material may furthermore include only one compound or substance, as mentioned above, or also any arbitrary mixture of different compounds and substances.

An energy store according to the present invention makes it possible to easily determine a state of health, e.g., in particular an aging condition, with the aid of sensory detection of breakdown and/or decomposition products, for example. These products may be derived from the electrolyte which is usually fluid, aprotic or also polymeric, or also from the anode or the cathode material or the reaction products of these two. According to the present invention, this type of functional material may be easily removed from the cell, introduced into an analysis unit and subsequently analyzed. With the aid of such an analysis, a fast, safe, and reliable determination of the aging condition of an energy store, for example, is made possible. Such an energy store may in this case be easily implemented in existing battery systems, e.g., battery state recognition systems or systems which include control units, an electric motor, and a generator.

It is thus, for example, possible with the aid of the energy store according to the present invention to reduce or completely avoid uncertainties with regard to the service life of the energy store and the prognoses associated therewith. Therefore, the applicability of the energy stores according to the present invention may be improved in numerous areas of application. In particular in the case of applications which place high demands on the service life and reliability of energy stores, e.g., in vehicles which are driven electrically either partially or completely, it is possible to allow for very exact prognoses with regard to the further service life of the energy store. Here, an ascertainment of a state of health, e.g., of the aging condition, of the energy store is possible independently of the cell geometry, i.e., for example, of whether the cell assumes a cylindrical or prismatic shape or forms a so-called pouch cell.

Within the scope of one embodiment, the energy store may have a plurality of cells, at least two of these cells having an outlet. In this embodiment, the energy store is thus formed from a module or a stack of a plurality of cells. In this embodiment, it is advantageous that not only one, but a plurality of cells, such as in particular at least two cells, have an outlet. In this way, the functional material is removable in a defined manner from a plurality of cells. This makes it possible for not only one cell to be examined for its state of health, but for a corresponding measurement to be made possible in a plurality of cells. In this way, it may be excluded, for example, that one cell has a defect and that this defect is then wrongly assumed for all cells, thus making it possible to prevent an unnecessary and premature replacement of electrolyte material, for example, or of the entire cell, thus saving unnecessary associated costs. Moreover, an averaged value of the aging condition, for example, may be formed across all cells by measuring a plurality of cells, so that one service makes sense for all cells alike. Aging peaks of individual cells may be detected in this way and assessed appropriately. For this purpose, it is, however, not necessary to examine all cells or to equip all cells with an outlet. It is sufficient if only a few cells are equipped with an outlet. For example, in the presence of several cell strands, one cell of each strand may include an outlet. Moreover, a statistically distributed number of cells may be equipped with an outlet. In this way, every fifth to every hundredth cell may have an outlet, for example. Overall, 0.5% to 20% of the cells present in an energy store may be equipped with an outlet, for example. It is understood within the scope of the present invention that it is, however, not excluded that all present cells have a corresponding outlet and may thus be analyzed.

Within the scope of another embodiment, a multi-way valve may be provided which may be fluidically connected to at least one outlet. For example, the multi-way valve may be situated in a terminal of the overall energy store. In this way, it may be selectively controlled which cell should be analyzed for its state of health. Thus, the connection to the cells may furthermore be closed for the time period during which functional material does not need to be removed from the cell or the cells, whereby the cells may continue to form a self-contained system during the normal course of operation even if the outlet of the cell is not directly closable, the latter being advantageous in some cases. This results in that a cell or an outlet of the cell or a connection between the cell and the outlet may essentially only be opened if a measurement is to take place. Without measurement, the operation of an energy store may therefore take place in an undisrupted manner. Here, it may in particular be advantageous that the cell or the cells merge in the multi-way valve. Furthermore, in particular if a multi-way valve is used, all cells may be measured in an arbitrary sequence and individually, if necessary. Thus, a measurement may be repeated in certain cells, for example, in order to repeat erroneous measurements, for example, or to verify certain measured values.

Within the scope of another embodiment, at least one outlet may be fluidically connected to a capillary, the capillary in particular having a diameter in a range of ≧0.1 mm to ≦10 mm. With the aid of capillaries, functional material may be removed from the interior of the cell particularly advantageously, by applying a vacuum, for example. Moreover, capillaries may be produced in almost any desired shape and may thus be effortlessly integrated into the interior of an energy store, for example. Here, a diameter of ≧0.1 mm to ≦10 mm may already be sufficient in order to remove a suitable quantity of functional material, it being possible to integrate the capillaries into an energy store in a very space-saving and thus effortless manner.

The subject matter of the present invention is furthermore a system which includes an energy store according to the present invention and an analysis unit, at least one cell and the analysis unit being connected to one another in a fluid-tight manner, functional material being conveyable from the cell to the analysis unit and the conveyed functional material being analyzable qualitatively and/or quantitatively with the aid of the analysis unit. With the aid of the system according to the present invention, it is particularly simple to ascertain a state of health of the energy store and, in this way, to provide prognoses with regard to the further service life of the energy store, for example.

Here, the system may, for example, be implemented as part of maintenance work in such a way that an energy store which is used in a mobile application, for example, or at least a cell of same is connectable or connected to an analysis unit which is situated centrally in a repair shop, for example. In this embodiment, it may be possible under certain circumstances to use a complex and costly analysis unit, for example, since it is employable for a plurality of energy stores and does not have to be provided for every energy store. Even high costs of an analysis unit are thus readily tolerable. In this way, a particularly safe and reliable analysis of the functional material may be ensured.

Furthermore, the system may be implemented, for example, on the location of the utilization of the energy store as one unit. For example, the system may be fully integrated into an electrically driven vehicle or into other mobile applications in order to enable the state of health of the energy store to be essentially ascertained at any time desired. In this embodiment, the utilization of cost-effective analysis units, e.g. suitable sensors, may be particularly advantageous in order to make equipment of a vehicle particularly suitable economically, for example. Suitable sensors in this case would be electrochemical sensors, for example, in particular for determining methanol, carbon monoxide, carbon dioxide, or hydrocarbons in general and functional material in particular. These cost-effective analysis units may then support complex analysis units, for example, within the scope of a normal service. However, an analysis may also be possible which is complete and carried out exclusively on board using the system integrated into a mobile application.

Subsequently, a state of health, such as in particular the aging condition, may be measured with the aid of a system according to the present invention during operation of a cell through sensory measurement inside the cell and also outside of operation during maintenance work through sensory measurement.

With regard to other advantages of the system according to the present invention, reference is explicitly made to the embodiments with regard to the energy store according to the present invention.

Within the scope of one embodiment, the analysis unit may include a chromatographic or a spectroscopic unit. With the aid of such analysis units, particularly accurate and reliable quantitative and qualitative analyses of the functional material are possible. In this way, the aging condition may be, for example, determined particularly reliably.

Exemplary analysis units include here, as an example and in a non-limiting manner, gas chromatographs (GC) or mass spectrometers (MS, GC-MS).

The subject matter of the present invention is furthermore a state recognition system, including a system according to the present invention. In particular within the scope of a state recognition system, the system according to the present invention may be employed particularly advantageously. Here, basically at any time of utilization of a system or an energy store, the aging condition of the energy store or of the corresponding cells may be ascertained, for example. Here, the system according to the present invention may be effortlessly integrated in most cases into a state recognition system.

In the sense of the present invention, a state recognition system may in particular be a system, using which at least one state of health of an energy store or of its cell or cells is ascertainable, in particular in an automated manner. For this purpose, the state recognition system may include the system according to the present invention, for example, and furthermore a control unit and an analysis unit in order to receive and evaluate, in particular in an automated manner, data with regard to the state of health.

Furthermore, reference is made to the embodiments regarding the energy store according to the present invention and the system according to the present invention with regard to the advantages of the state recognition system according to the present invention.

The subject matter of the present invention is furthermore a method for determining a state of health of an energy store having at least one cell which includes an anode, a cathode, and an electrolyte which is situated between the anode and the cathode, including the method steps:
a) removing at least a portion of functional material from at least one cell through an outlet which is connected to an analysis unit in a fluid-tight manner;
b) introducing the removed functional material into an analysis unit; and
c) analyzing the functional material qualitatively and/or quantitatively.

With the aid of the method according to the present invention, a state of health of an energy store, e.g., in particular a lithium-based battery, may be safely and reliably ascertained. For this purpose, the method may be carried out easily and quickly. Furthermore, a state of health of an energy store is, for example, ascertainable in a stationary and in a mobile manner with the aid of the method according to the present invention.

A state of health of an energy store or a cell may in this case be understood to mean any state which relates to the function of the cell or the energy store and is furthermore analyzable with the aid of an analysis of functional material. In particular, a state of health may be understood to mean the aging condition of the energy store.

In the method according to the present invention, the type of aging may be inferred from the type of the examined or detected material in one specific embodiment. It may be ascertained in this way, for example, whether aging has taken place in the anode, the cathode, or the electrolyte. For the case that only material is detected, for example, which infers aging of the electrolyte, the electrolyte may be selectively replaced without having to replace the entire cell. Consequently, a highly selective examination of the energy store with regard to its aging condition is in particular possible with the aid of the method according to the present invention. Moreover, a reliable assessment regarding the degree of the aging condition may be made possible with the aid of the quantity of the detected material. In this way, an accurate prognosis with regard to the further service life of the energy store is possible, for example, which may be particularly advantageous if the method according to the present invention is carried out repeatedly in defined time intervals. In this case, a precise course of aging may be ascertained, while being able to isolate individual components.

Moreover, the method according to the present invention may be carried out using a minimum quantity of functional material. For example, it is sufficient as a function of the cell size if a quantity of ≧0.1 ml to ≦10 ml of functional material is used, or removed from the cell as a sample and introduced into the analysis unit, to carry out the method.

Reference is, in particular, made to the embodiments regarding the energy store according to the present invention and the system according to the present invention with regard to further advantages of the method according to the present invention.

Within the scope of one embodiment, the functional material may be examined qualitatively and/or quantitatively with regard to breakdown products, decomposition products and/or reaction products of anode material, cathode material and/or electrolyte material. In particular by examining such materials, the aging condition may be ascertained particularly accurately and reliably. In detail, decomposition and breakdown products are generated, in particular, during aging of the energy store, thus allowing for reliable evidence of the type and the degree of the aging condition of the energy store.

The breakdown and decomposition products, in the form of functional material, for example, occurring in the course of aging of the energy store may be or include the following components which are largely independent of the type of the used, in particular organic, electrolyte system: hydrogen (H₂), carbon monoxide (CO), carbon dioxide (CO₂), methane (CH₄), ethane (C₂H₆), ethylene (C₂H₄). Furthermore, the following gaseous substances may also occur as functional material, in particular in smaller concentrations: propane (C₃H₈), propylene or cyclopropane (C₃H₆), butane or isobutane (C₄H₁₀), hydrogen fluoride (HF), lithium fluoride (LiF), lithium phosphate (LiH₂PO₄), phosphorus pentoxide (P₂O₅), lithium alcoholates, lithium carbonate (Li₂CO₃), lithium hydroxide (LiOH). In particular in lithium sulfur batteries, the following components may furthermore occur in larger quantities: hydrogen sulfide (H₂S), sulfur dioxide (SO₂), sulfur trioxide (SO₃), lithium hydrogen sulfide (LiHS), the following components occurring in particular in smaller concentrations: Carbon sulfur compounds (CₓS_{y}), lithium sulfite (Li₂SO₃), lithium sulfate (Li₂SO₄), lithium thiosulfate (Li₂S₂O₃), or lithium persulfate (Li₂S₂O₈).

Within the scope of another embodiment, functional material may be introduced into the cell during and/or after the removal of functional material from the cell. In this way, the quantity of functional material present in the cell may be kept constant so that even in the case of a repeated removal of functional material which is necessary for a charging or discharging process, there is no risk of drop in capacity.

Further advantages and advantageous embodiments of the subject matters of the present invention are illustrated by the drawing and explained in the following description. It should be noted that the drawing is only descriptive in nature and is not intended to limit the present invention in any way.

### BRIEF DESCRIPTION OF THE DRAWING

FIG. 1 shows a schematic illustration of one specific embodiment of a system according to the present invention.

### DETAILED DESCRIPTION

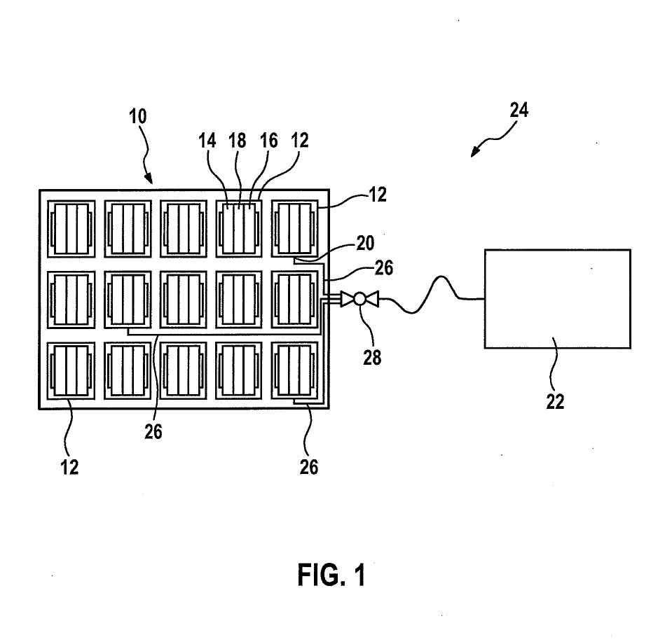

In FIG. 1, an energy store 10 according to the present invention is shown. Energy store 10 may be a lithium-based energy store, for example, such as a lithium battery or a lithium-ion battery. Moreover, sodium-based or nickel-based energy stores, e.g., NiCd or NiMH energy stores, are possible within the scope of the present invention in a non-restricting manner. Energy store 10 according to the present invention may be used in all types of mobile and stationary applications. Non-restricting examples include in this case power tools, gardening tools, computers, electric vehicles, hybrid and plug-in hybrid vehicles. Energy store 10 according to the present invention is in particular advantageous where a state of health, e.g., the aging condition, is of particular interest, i.e., in particular in those applications for which a plurality of cells or batteries is desirable for a long service life.

Energy store 10 according to the present invention includes at least one cell 12. The energy store includes according to FIG. 1 a plurality of cells 12. In particular, each of cells 12 has an anode 14, a cathode 16, and an electrolyte 18 which is situated between anode 14 and cathode 16. Here, at least one cell 12 has an outlet 20. This outlet 20 is used in particular to convey functional material from cell 12 to an analysis unit 22, such as a chromatographic or a spectroscopic unit. Here, it is apparent in FIG. 1 that outlet 20 is connected to analysis unit 22 in a fluid-tight manner.

Energy store 10 forms together with analysis unit 22 a system 24 according to the present invention which may be part of a state recognition system.

FIG. 1 furthermore shows that energy store 10 has a plurality of cells 12 of which at least two cells 12, three cells 12 according to FIG. 1, have a corresponding outlet 20. Here, at least one outlet 20 or one cell 12, three cells 12 according to FIG. 1, is fluidically connected to one capillary 26 in each case. In this case, capillary 26 may have a diameter in a range of ≧0.1 mm to ≦10 mm. Furthermore, a valve 28, e.g., in particular a multi-way valve, may be provided which is fluidically connected to outlets 20. In particular, connecting arrangement, e.g., capillaries 26, which are connected to the particular outlet 20 may merge in this valve 28. In other words, the void volumes of cells 12 may be guided to the outside to a closing valve 28, e.g., in particular a multi-way valve, with the aid of thin capillaries 26. Here, a suitable terminal, e.g., a screw thread, may be provided at outlet 20 and/or at valve 28.

With the aid of the embodiment of system 24 according to the present invention, functional material may be conveyed from cell 12 or the plurality of cells 12 to analysis unit 22 and analyzed qualitatively and/or quantitatively by analysis unit 22. Valve 28 may, for example, be connected to analysis unit 22, it being possible to furthermore connect a conveyor, such as a vacuum pump, to valve 28 or to the interior of cell 12. In this way, functional material, e.g., in particular gaseous or liquid materials, may be removed from the interior of cell 12 and introduced into analysis unit 22 by applying a vacuum.

A method of this type includes in particular the following method steps:
a) removing at least a portion of the functional material from at least one cell 12 through an outlet 20 which is connected to an analysis unit 22 in a fluid-tight manner;
b) introducing the removed functional material into an analysis unit 22; and
c) analyzing the functional material qualitatively and/or quantitatively.

The detection of the functional material described above, in particular the sensory detection, is thus possible by removing fluid, i.e., in particular gaseous or liquid, materials from one cell or a plurality of cells 12 and introducing it into analysis unit 22. In particular, functional material may be analyzed qualitatively and/or quantitatively with regard to breakdown products, decomposition products and/or reaction products of the anode, the cathode or the electrolyte. The type of occurred aging, for example, may be inferred based on the qualitative occurrence of certain products. The quantity of the detected substances may furthermore provide specific information regarding the degree of aging. This information may be used, among other things, to predict the further service life of energy store 10 or also to determine the optimal point in time for replacing a component of cell 12, e.g., electrolyte 18, in order to extend the overall service life of energy store 10.

In particular as a function of the quantity of the removed functional material, functional material, e.g., electrolyte material, may be introduced into cell 12 during and/or after the removal of functional material from cell 12. This may be implemented in particular via the conveying system described above.

1-10. (canceled)

11. An energy store, comprising:
at least one cell having an anode, a cathode, and an electrolyte which is situated between the anode and the cathode;
wherein at least one cell has an outlet for conveying functional material from the cell to an analysis unit, and
wherein the outlet is connectable to the analysis unit in a fluid-tight manner

12. The energy store of claim 11, wherein the energy store has a plurality of cells of which at least two cells have an outlet.

13. The energy store of claim 12, further comprising:
a multi-way valve which is fluidically connected to at least one of the outlets.

14. The energy store of claim 11, wherein at least one outlet is fluidically connected to a capillary, which has a diameter in a range of ≧0.1 mm to ≦10 mm.

15. A system, comprising:
an energy store, including:
at least one cell having an anode, a cathode, and an electrolyte which is situated between the anode and the cathode, wherein at least one cell has an outlet for conveying functional material from the cell to an analysis unit, and wherein the outlet is connectable to the analysis unit in a fluid-tight manner; and
an analysis unit;
wherein at least one cell and the analysis unit are connected to one another in a fluid-tight manner, wherein the functional material is conveyable from the cell to the analysis unit, and wherein the conveyed functional material is analyzable at least one of qualitatively and quantitatively with the analysis unit.

16. The system of claim 15, wherein the analysis unit includes one of a chromatographic unit and a spectroscopic unit.

17. A state recognition system, comprising:
a system, including an energy store having at least one cell having an anode, a cathode, and an electrolyte which is situated between the anode and the cathode, wherein at least one cell has an outlet for conveying functional material from the cell to an analysis unit, and wherein the outlet is connectable to the analysis unit in a fluid-tight manner, and having an analysis unit;
wherein at least one cell and the analysis unit are connected to one another in a fluid-tight manner, wherein the functional material is conveyable from the cell to the analysis unit, and wherein the conveyed functional material is analyzable at least one of qualitatively and quantitatively with the analysis unit.

18. A method for determining a state of health of an energy store having at least one cell which has an anode, a cathode, and an electrolyte which is situated between the anode and the cathode, the method comprising:
removing at least a portion of the functional material from at least one cell through an outlet which is connected to an analysis unit in a fluid-tight manner;
introducing the removed functional material into the analysis unit; and
analyzing the functional material qualitatively and/or quantitatively.

19. The method of claim 18, wherein the functional material is analyzed at least one of qualitatively and quantitatively with regard to at least one of breakdown products, decomposition products and reaction products of at least one of an anode material, a cathode material and an electrolyte material.

20. The method of claim 18, wherein at least one of during and after the removal of functional material from the cell, functional material is introduced into the cell.

21. The energy store of claim 11, wherein the energy store is a lithium-based energy store.
